(19) United States
(12) Patent Application Publication
(10) Pub. No.: US 2006/0168226 A1
(43) Pub. Date: Jul. 27, 2006

(54) Method, computer-readable medium, and apparatus for scheduling the availability of versions of a network resource

(75) Inventors: Patrick C. Miller, Sammamish, WA (US); Ryan R. Stocker, Seattle, WA (US); Stephen G. Cawood, Vancouver (CA)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/997,391

(22) Filed: Nov. 24, 2004

(51) Int. Cl. G06F 15/173; G06F 15/16

(52) U.S. Cl. 709/226; 709/217

(57) ABSTRACT

A method, computer-readable medium, and apparatus are provided for allowing scheduled access to a network resource, such as a Web page. According to the method, a uniform resource locator (“URL”) may be assigned to a scheduled URL object (“SUO”). When a request is received at the URL assigned to the SUO, a schedule associated with the SUO is identified. Based on the schedule, a version of the network resource to be provided in response to a request to access the URL is identified. The version of the network resource to be provided is then returned in response to the request received at the URL.

### BACKGROUND OF THE INVENTION

Complex World Wide Web (“WWW” or “Web”) sites are often created with the assistance of a content management system (“CMS”). Through the use of a CMS, a content-rich Web site can be built, deployed and maintained. Additionally, some content management systems allow computer users to create and add content to a Web site without understanding the underlying technical details of the site. A content approval workflow can also be implemented by a CMS to ensure that content is approved by authorized individuals prior to being made publicly available on the Web site.

One shortcoming of current CMS systems involves their inability to schedule the availability of future versions of a Web page. In particular, it is often necessary to schedule Web pages to come online at some future time. For example, it may be desirable to schedule a Web page describing new products to come online on the precise date and at the precise time a product announcement is released. Moreover, it may be desirable to schedule any number of future versions of the same Web page to come online at arbitrary times in the future. This allows content creators to build future versions of a Web page well in advance of their deployment date.

Some current content management systems allow two versions of a Web page to exist, the current version of the page and a checkout-out version of the page for editing. When the checkout-out version of the Web page is checked into the CMS, the current version of the page will be replaced. However, the newly checked-in version of the Web page will not be available until its deployment date. This can cause requests for the page to go unfulfilled, leading to user confusion and potentially the loss of business.

It is with respect to these considerations and others that the various embodiments of the present invention have been made.

### BRIEF SUMMARY OF THE INVENTION

In accordance with the present invention, the above and other problems are solved by a method, computer-readable medium, and apparatus for scheduling the availability of different versions of a network resource, such as a Web page. Through the embodiments of the invention, a separate workflow may be created within a CMS for different versions of the same Web page. A schedule may also be created and utilized that allows any number of future versions of a Web page to be made available at any future time.

According to one aspect of the invention, a method is provided for allowing scheduled access to a network resource, such as a Web page. According to the method, a request is received for a network resource. In response to the request, a version of the network resource to return in response to the request is identified based upon a schedule. The identified version of the network resource is then returned in response to the request. According to other aspects of the invention, the network resource may be identified by a uniform resource locator (“URL”) and the request for the network resource may comprise a request received at the URL. Moreover, the schedule may be associated with the URL and may identify a date on which the various versions of the network resource should be made available.

According to other aspects of the invention, a computer-readable medium is provided that has computer-executable instructions stored thereon. When executed by a computer, the computer-executable instructions cause the computer to assign a URL to a scheduled URL object (“SUO”). When a request is received at the URL assigned to the SUO, a schedule associated with the SUO is identified. Based on the schedule, a version of the network resource to be provided in response to a request to access the URL may be identified. The version of the network resource to be provided may then be returned in response to the request received at the URL.

According to other aspects of the invention, a server-side redirect to the location of the identified version of the network resource may be performed. This allows the version of the network resource to be returned without affecting the URL seen by the user requesting the network resource. Once the redirect has been performed, the network resource may be rendered and returned to the user in response to the request to access the URL.

The invention may be implemented as a computer process, a computing apparatus, or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features, as well as advantages, which characterize the present invention, will be apparent from a reading of the following detailed description and a review of the associated drawings.

### BRIEF DESCRIPTION OF THE SEVERAL VIEWS OF THE DRAWINGS

FIG. 1 is a computer network diagram illustrating aspects of several computer systems utilized in and provided by the various embodiments of the invention;

FIG. 2 is a computer system architecture diagram illustrating additional aspects of several computer systems utilized in and provided by the various embodiments of the invention;

FIGS. 3 and 4 are computer system software diagrams illustrating aspects of the operation of various embodiments of the invention; and

FIGS. 5 and 6 are flow diagrams illustrating aspects of a process for providing scheduled access to different versions of a network resource according to one embodiment of the invention.

### DETAILED DESCRIPTION OF THE INVENTION

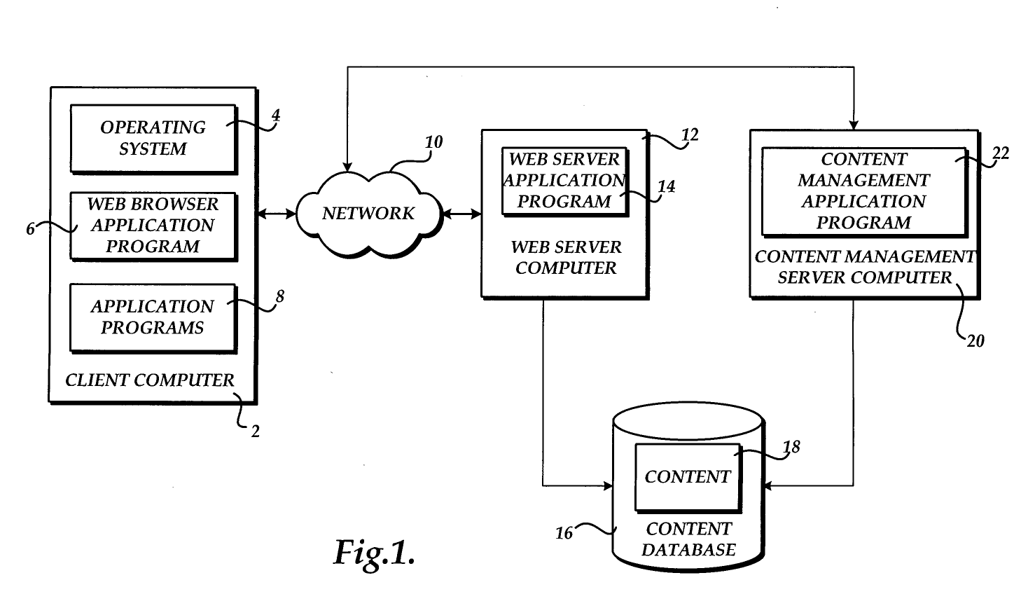

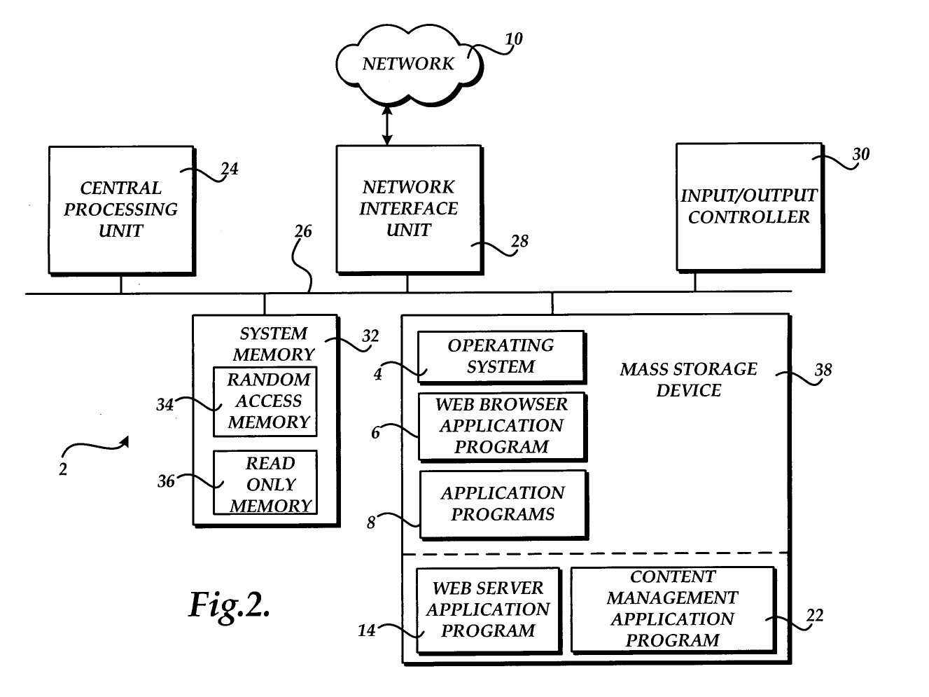

Referring now to the drawings, in which like numerals represent like elements, various aspects of the present invention will be described. In particular, FIGS. 1 and 2 and the corresponding discussion are intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 1, an illustrative operating environment for the several embodiments of the invention will be described. As shown in FIG. 1, a network 10 interconnects a client computer 2 and several server computers 12 and 20. It should be appreciated that the network 10 may comprise any type of computing network, including a local area network or a wide area network, such as the Internet. The network 10 provides a medium for enabling communication between the client computer 2, the server computers 12 and 20, and potentially other computer systems connected to or accessible through the network 10.

The client computer 2 comprises a general purpose desktop or laptop computer capable of executing one or more application programs. In particular, according to the various embodiments of the invention, the computer 2 is operative to execute an operating system 4, a Web browser application program 6, and other application programs 8. As known to those skilled in the art, the Web browser application program 6 allows a user of the client computer 2 to request, view, and interact with network resources available through the network 10. In particular, a user of the client computer 2 may utilize the Web browser 6 to request content 18 from the Web server computer 12. The content 18 may comprise any type of network resource available via the network 10, such as a Web page, text page, image, executable program, or any other type of data file.

When a request for content 18 is received at the Web server computer 12 it is processed by the Web server application program 14. As known to those skilled in the art, a Web server application program is operative to receive and respond to requests for data accessible to the Web server computer 14. As shown in FIG. 1, the content 18 may be stored in a content database 16 accessible to the Web server computer 12. Other types of network resources stored in other locations may also be served by the Web server application program 14.

As shown in FIG. 1, the server computer 20 comprises a content management server computer that is operative to execute a content management system application program 22. The CMS program 22 provides an interface through which the content 18 may be created, deployed, and maintained. In particular, a user of the client computer 2 may utilize one or more of the application programs 8 and the CMS 22 to edit and publish the content 18. The content 18 may then be made accessible to other computers on the network 10 by the Web server computer 12. It should be appreciated that the CMS 22 supports approval workflows for the content 18 and other features known to those skilled in the art.

As will be described in greater detail below, the CMS 22 supports independent workflows for any number of versions of the content 18. For instance, different versions of the content 18 may be created that exist simultaneously. Each of the different versions of the content 18 may utilize a different approval workflow within the CMS 22. Moreover, a deployment schedule may be specified for each of the versions that specifies the date and time at which the version should be made available by the Web server computer 12. As will be described in greater detail below, the schedule is utilized by the Web server computer 12 to determine which version of the content 18 to utilize when responding to a request for the content. Additional details regarding the configuration and operation of the computers 2, 12, and 20 will be provided below with respect to FIGS. 2-6.

Referring now to FIG. 2, an illustrative computer architecture for a computer 2 utilized in the various embodiments of the invention will be described. The computer architecture shown in FIG. 2 illustrates a conventional desktop or server computer, including a central processing unit 24 (“CPU”), a system memory 32, including a random access memory 34 (“RAM”) and a read-only memory (“ROM”) 36, and a system bus 26 that couples the memory to the CPU 24. A basic input/output system containing the basic routines that help to transfer information between elements within the computer, such as during startup, is stored in the ROM 36. The computer 2 further includes a mass storage device 38 for storing an operating system 4, application programs, and other program modules, which will be described in greater detail below.

The mass storage device 38 is connected to the CPU 24 through a mass storage controller (not shown) connected to the bus 26. The mass storage device 38 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 10, such as the Internet. The computer 2 may connect to the network 10 through a network interface unit 28 connected to the bus 26. It should be appreciated that the network interface unit 28 may also be utilized to connect to other types of networks and remote computer systems. The computer 2 may also include an input/output controller 30 for receiving and processing input from a number of other devices, including a keyboard, mouse, or electronic stylus (not shown in FIG. 2). Similarly, an input/output controller 30 may provide output to a display screen, a printer, or other type of output device.

As mentioned briefly above, a number of program modules and data files may be stored in the mass storage device 38 and RAM 34 of the computer 2, including an operating system 4 suitable for controlling the operation of a networked computer, such as the WINDOWS XP operating system from MICROSOFT CORPORATION of Redmond, Wash. The mass storage device 38 and RAM 34 may also store one or more program modules. In particular, the mass storage device 38 and the RAM 36 may store a Web browser application program, such as the INTERNET EXPLORER Web browser application program from MICROSOFT CORPORATION. The mass storage device 28 and RAM 34 may also store one or more other application programs 8, such as the MICROSOFT OFFICE productivity suite from MICROSOFT CORPORATION. The Web browser 6 and application programs 8 may be utilized to create, deploy, and maintain a Web site through the CMS program 22. The Web browser 6 may also be utilized to view and interact with the contents of a Web site.

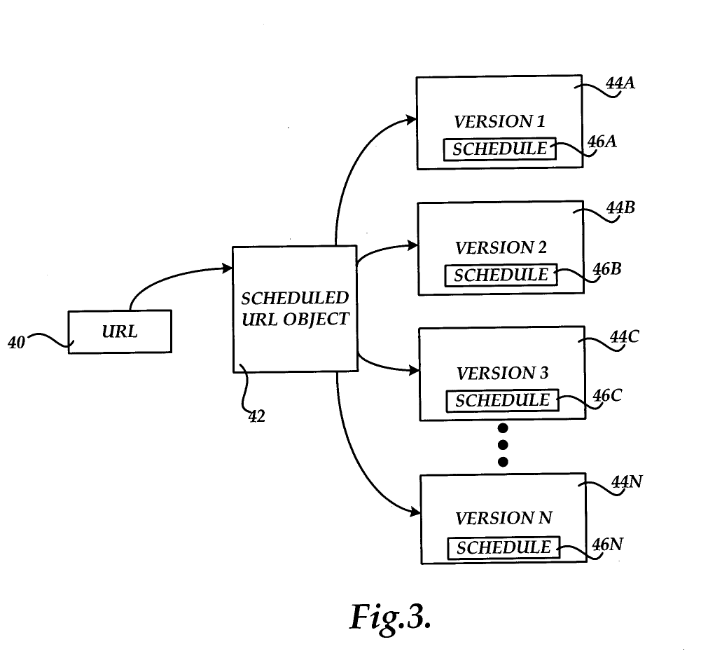

It should be appreciated that the server computers 12 and 20 may include many of the conventional computing components illustrated in FIG. 2 and described above. Additionally, the Web server computer 12 may be operative to store and execute a Web server application program 14, such as the INTERNET INFORMATION SERVER from MICROSOFT CORPORATION. The CMS server computer 20 may be operative to store and execute a CMS program 22, such as the CONTENT MANAGEMENT SERVER from MICROSOFT CORPORATION. Additional details regarding the operation of the Web server application program 14 and the CMS program 22 will be provided below with respect to FIGS. 3-6. It should be appreciated that the server computers 12 and 20 may include other conventional components not illustrated in FIG. 2 but known to those skilled in the art.

Referring now to FIG. 3, additional details regarding the various embodiments of the invention will be described. As shown in FIG. 3, a uniform resource locator (“URL”) 40 may be associated with a scheduled URL object 42 (“SUO”). The SUO 42 is an object maintained by the Web server computer 12. When a request is received at the URL 40 associated with the SUO 42, the Web server computer 12 will identify a schedule associated with the SUO 42. The schedule describes the dates and times at which different versions of a network resource should be made available by the Web server 12.

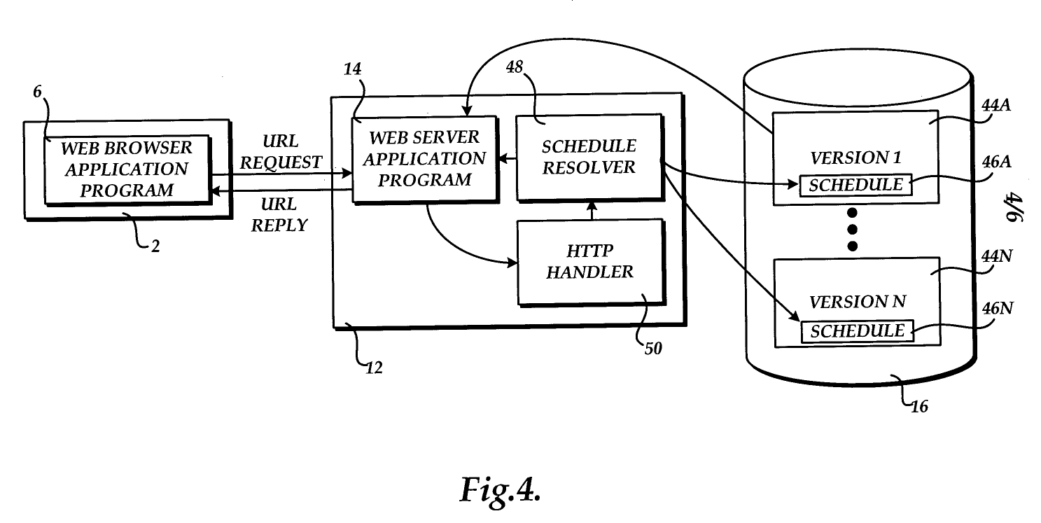

As shown in FIG. 3, each version 44A-44N of a network resource may have an associated schedule 46A-46N that describes when that version should be utilized by the Web server computer 12 to respond to requests received at the URL 40. The schedule may be specified by a user of the client computer 2 when using the CMS program 22 to build each of the versions 44A-44N of the network resource. It should be understood that each of the versions 44A-44N comprises a different version of the same network resource. Moreover, it should be understood that a request received at a URL 40 associated with a SUO 42 causes the Web server computer 12 to examine the schedule to determine which version of the network resource should be returned in response to the request received at the URL 40. Additional details regarding this process are provided below with respect to FIGS. 4-6.

Turning now to FIG. 4, additional details regarding the various processes provided herein for scheduling the deployment of network resources will be provided. As shown in FIG. 4, the client computer 2 executes the Web browser application program 6. The Web browser application program 6 may be utilized to request a network resource located at a URL from the Web server computer 12. When a URL request is received at the Web server computer 12, the Web server application program 14 routes the request to a hyper-text transfer protocol (“HTTP”) handler 50.

The HTTP handler 50 determines if the URL is associated with a SUO. If the URL is associated with a SUO, the HTTP handler 50 routes the URL request to a schedule resolver 48. The schedule resolver 48 locates the schedules 46A-46N for deployment of the versions 44A-44N of the network resource associated with the requested URL. Based on the dates and times contained within the schedules 46A-46N and the current date and time, the schedule resolver 48 determines the proper version 44A-44N of the network resource to be returned. It should be appreciated that although the schedules 46A-46N are illustrated in FIG. 4 as being stored separately for each version 44A-44N, the schedule for all versions may be stored in a common location.

Once the proper version of the network resource to be returned has been identified, the schedule resolver 48 performs a client-side redirect to the appropriate version of the network resource. Alternatively, the URL may be rewritten to point to the location of the version of the network resource to be returned. The redirected or rewritten URL is then returned to the Web server application program 14. The Web server application program 14 then retrieves the proper version of the network resource, renders the resource, and returns the results to the Web browser application program 6 in the form of a reply to the original URL request. It should be appreciated that by performing a server-side redirect or rewriting the URL, the user of the client computer 2 only sees the original URL they provided. They do not see the URL of the actual version of the network resource that is returned.

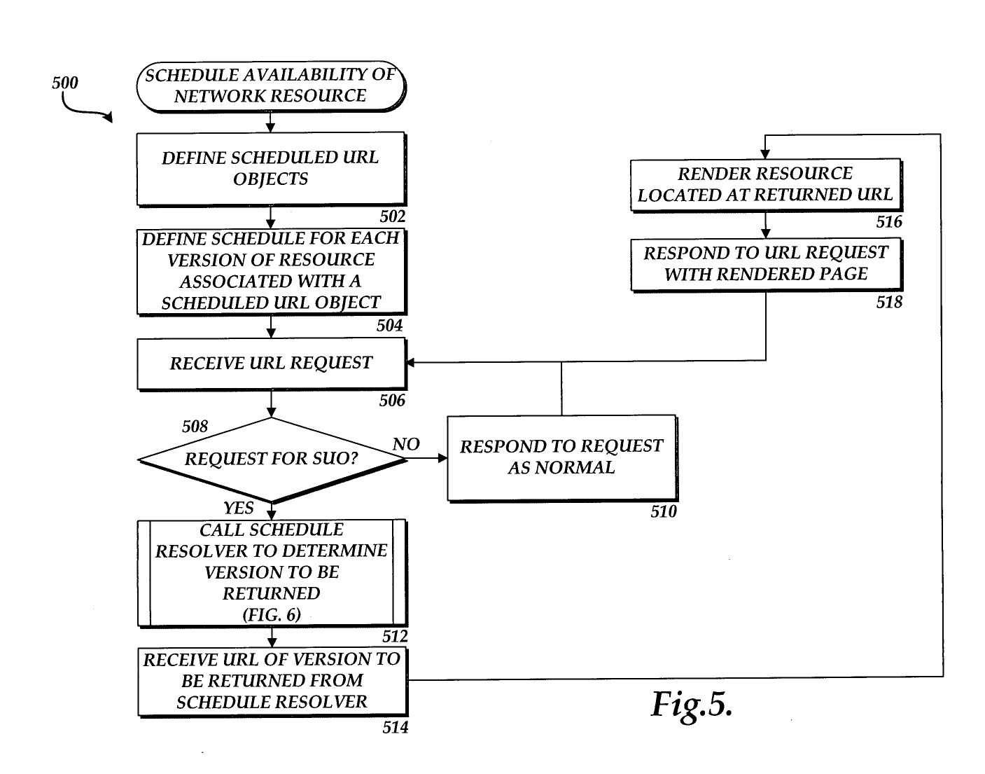

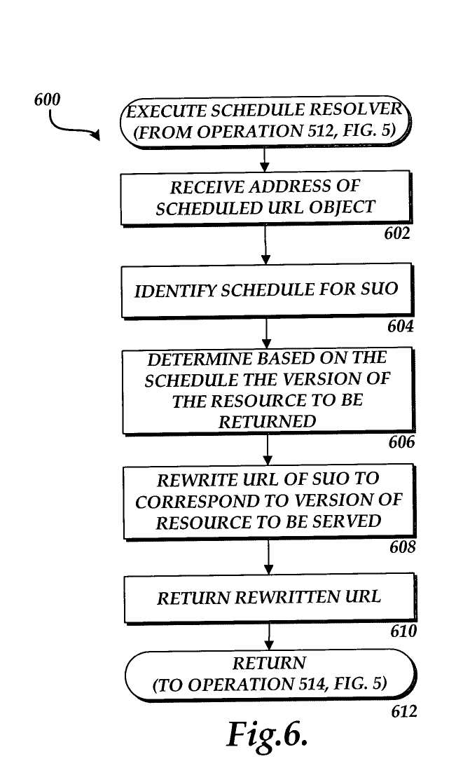

Referring now to FIG. 5, an illustrative routine 500 will be described illustrating a process for scheduling the availability of a network resource. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIGS. 5-6 and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 500 begins at operation 502, where a user defines the scheduled URL objects for a URL. The definition includes associating a URL with a particular SUO. The routine 500 then continues to operation 502, where a schedule is defined for each version of a network resource associated with a SUO. For instance, when a user is creating a new version of a network resource using the CMS 22, the user may specify a date and time for deployment of the new version. When the version is checked in, the date and time information and a pointer to the new version are added to the SUO.

From operation 504, the routine 500 continues to operation 506, where a URL request is received by the Web server application program 14. At operation 508, a determination is made as to whether the requested URL is associated with an SUO. A list of URLs and their associated SUOs may be maintained by the Web server application program 14 and the HTTP handler 50 to assist in making this determination. If the requested URL is not associated with an SUO, the routine 500 branches to operation 510, where the request is processed and responded to in a normal fashion. The routine 500 then returns from operation 510 to operation 506, where additional requests are processed in a similar fashion.

If, at operation 508, it is determined that the requested URL is associated with an SUO, the routine 500 continues to operation 512. At operation 512, the schedule resolver 48 is called with the requested URL to determine the proper version of the network resource that should be returned in response to the URL request. Additional details regarding the operation of the schedule resolver 48 in this regard are provided below with respect to FIG. 6.

From operation 512, the routine 500 continues to operation 514, where the URL of the version to be returned in response to the URL request is received from the schedule resolver 48. The Web server application program 14 then retrieves and renders the version of the network resource located at the URL returned by the schedule resolver at operation 516. At operation 518, the Web server application program 14 returns the rendered page to the requestor at operation 518. The routine 500 then returns from operation 518 to operation 506, where additional requests are processed in a similar fashion.

Turning now to FIG. 6, an illustrative routine 600 showing the operation of the schedule resolver 48 will be described. The routine 600 begins at operation 602, where the address of the SUO is received from the HTTP handler 50. Based on the SUO, the schedule resolver 48 identifies the schedule at operation 604. At operation 606, the schedule resolver 48 identifies the version of the network resource to be returned. This determination is made based on the contents of the schedule associated with the SUO and the current date and time.

From operation 606, the routine 600 continues to operation 608, where the URL is rewritten to correspond to the version of the network resource to be returned. Alternatively, a server-side redirect may be performed to the version of the network resource to be returned. This operation is performed so that the URL visible in the Web browser application program 6 is not modified. From operation 608, the routine 600 continues to operation 610 where the rewritten or redirected URL is returned to the Web server application program 14. The routine 600 then continues to operation 612, where it returns to operation 514, described above with respect to FIG. 5.

Based on the foregoing, it should be appreciated that the various embodiments of the invention include a method, system, apparatus, and computer-readable medium for scheduling the availability of different versions of a network resource. The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for providing access to a network resource, the method comprising:
receiving a request for a network resource
identifying based on a schedule a version of the network resource to return; and
returning the identified version of the network resource in response to the request.

2. The method of claim 1, wherein the network resource is identified by a uniform resource locator and wherein the request for the network resource comprises a request received at the uniform resource locator.

3. The method of claim 2, wherein the schedule is associated with the uniform resource locator and wherein the schedule identifies a date on which one or more versions of the network resource should be made available.

4. The method of claim 3, further comprising determining a location of the identified version of the network resource, performing a server-side redirect to the location, and rendering the identified version of the network resource.

5. A computer-controlled apparatus capable of performing the method of claim 1.

6. A computer-readable medium having computer-executable instructions stored thereon which, when executed by a computer, cause the computer to:
receive a request for a network resource;
identify based on a schedule a version of the network resource to return; and
to return the identified version of the network resource in response to the request.

7. The computer-readable medium of claim 6, wherein the network resource is identified by a uniform resource locator and wherein the request for the network resource comprises a request received at the uniform resource locator.

8. The computer-readable medium of claim 7, wherein the schedule is associated with the uniform resource locator and wherein the schedule identifies a date on which one or more versions of the network resource should be made available.

9. The computer-readable medium of claim 8, comprising further computer-executable instructions which, when executed by a computer, will cause the computer to:
determine a location of the identified version of the network resource;
perform a server-side redirect to the location; and
render the identified version of the network resource.

10. A method for providing access to a scheduled network resource, the method comprising:
assigning a uniform resource locator to a scheduled uniform resource locator object;
receiving a request at the uniform resource locator;
in response to the request, identifying a schedule associated with the scheduled uniform resource locator object;
determining based on the schedule a version of a network resource to be provided in response to the request; and
replying to the request with the identified version of the network resource.

11. The method of claim 10, further comprising:
determining a location of the identified version of the network resource;
performing a server-side redirect to the location; and
rendering the identified version of the network resource.

12. A computer-controlled apparatus capable of performing the method of claim 10.

13. A computer-readable medium having computer-executable instructions stored thereon which, when executed by a computer, cause the computer to:
assign a uniform resource locator to a scheduled uniform resource locator object;
receive a request at the uniform resource locator;
in response to the request, to identify a schedule associated with the scheduled uniform resource locator object;
to determine based on the schedule a version of a network resource to be provided in response to the request; and
to reply to the request with the identified version of the network resource.

14. The computer-readable medium of claim 13, wherein the network resource comprises a web page.

15. A method for providing access to a scheduled network resource, the method comprising:
assigning a uniform resource locator to a scheduled uniform resource locator object;
receiving a request at the uniform resource locator;
in response to the request, identifying a schedule associated with the scheduled uniform resource locator object;
determining based on the schedule a version of a network resource to be provided in response to the request; and
replying to the request with the identified version of the network resource.

16. The method of claim 15, wherein the network resource comprises a web page.

17. A computer-controlled apparatus capable of performing the method of claim 15.

18. A computer-readable medium having computer-executable instructions stored thereon which, when executed by a computer, cause the computer to:
receive a request at a network location for a network resource;
to determine whether the network location is associated with a scheduled uniform resource locator object;
in response to determining that the network location is associated with a scheduled uniform resource locator object, to locate a schedule associated with the scheduled uniform resource locator object;
to determine, based upon the schedule, the identity of a version of a network resource to be returned in response to the request;
perform a server side redirect to the identified version of the network resource;
render the identified version of the network resource; and
to return the rendered version of the network resource in response to the request for the network resource.

19. A method for providing access to a scheduled network resource, the method comprising:
receiving a request at a network location for a network resource;
determining whether the network location is associated with a scheduled uniform resource locator object;
in response to determining that the network location is associated with a scheduled uniform resource locator object, locating a schedule associated with the scheduled uniform resource locator object;
determining, based upon the schedule, the identity of a version of a network resource to be returned in response to the request;
performing a server side redirect to the identified version of the network resource;
rendering the identified version of the network resource; and
returning the rendered version of the network resource in response to the request for the network resource.

20. A computer-controlled apparatus capable of performing the method of claim 19.
